(19) United States
(12) Patent Application Publication
(10) Pub. No.: US 2020/0168019 A1
(43) Pub. Date: May 28, 2020

(54) GARAGE DOOR SENSING

(71) Applicant: Personal and Recreational Products, Inc., Westlake, TX (US)

(72) Inventor: Timothy A. Shiner, Westlake, TX (US)

(73) Assignee: Personal and Recreational Products, Inc., Westlake, TX (US)

(21) Appl. No.: 16/695,959

(22) Filed: Nov. 26, 2019

Related U.S. Application Data
(60) Provisional application No. 62/772,176, filed on Nov. 28, 2018.

(51) Int. Cl. G07C 9/10; G07C 9/00

(52) U.S. Cl. CPC G07C 9/10; G07C 2009/00928; G07C 9/00896

(57) ABSTRACT

A garage door sensor system includes a door mounting portion, a floor mounting portion, a first proximity sensor part connected to a wireless transmitter, and a second proximity sensor part.

### CROSS-REFERENCE TO RELATED PATENT APPLICATIONS

This application claims the benefit of priority to U.S. Patent Application No. 62/772,176, filed Nov. 28, 2018, the contents of which are incorporated by reference herein.

### BACKGROUND

Many households install security systems in order to secure and protect their homes from unwanted visitors. Home security systems can include many features, for example, surveillance cameras and alarms that trip after certain conditions are met. Such security systems can be installed as an additional layer of protection not only for residents in the home but also for their belongings.

### SUMMARY

One general aspect includes a garage door sensor system, including: a floor mounting portion configured to withstand a vehicle running over it. The garage door sensor system also includes a door mounting portion; a first proximity sensor part with the floor mounting portion or the door mounting portion; a second proximity sensor part with the other of the floor mounting portion or the door mounting portion. The first proximity sensor part is adapted to change states when the second proximity sensor part is moved between residing apart from the first proximity sensor part and touching or residing in proximity to the first proximity sensor part. The system also includes a wireless transmitter coupled to communicate with the first proximity sensor part and transmit the state of the proximity sensor wirelessly.

In certain instances, the first proximity sensor part is coupled to the floor mounting portion and the second proximity sensor part is coupled to the door mounting portion. In certain instances, the first proximity sensor part is coupled to the door mounting portion and the second proximity sensor part is coupled to the floor mounting portion. In certain instances, the wireless transmitter is coupled to the door mounting portion. In certain instances, the floor mounting portion includes a metallic weatherproof housing. In certain instances, the first proximity sensor part is coupled to the floor mounting portion. The garage door sensor system may also include the first proximity sensor part connected to the wireless transmitter by a cable and the wireless transmitter external to the floor mounting portion enclosed in a radio frequency transmissive, weatherproof housing. In certain instances, the floor mounting portion is fastened to a garage floor. In certain instances, there is an adhesive between the floor mounting portion and the garage floor. The garage door sensor system can have the floor mounting portion weatherproofed. In certain instances, the door mounting portion is fastened to a garage door.

One general aspect includes a method, including: generating a signal by a first proximity sensor part in response to a second proximity sensor part being moved away from the first proximity sensor part. The method also includes transmitting, by a wireless transmitter connected to the first proximity sensor part, a first signal in response to the signal of the first proximity sensor part; and withstanding a vehicle running over the first proximity sensor part.

One general aspect includes a door sensor system, including: a first portion configured to mount to a garage floor and withstand a vehicle repeatedly running over it; a second portion configured to mount to a garage door. The door sensor system also includes a sensor adapted to sense proximity of the first and second portions. The door sensor system also includes a wireless transmitter coupled to the sensor in a weatherproof housing at least a portion of which is radio transmissive.

### DESCRIPTION OF DRAWINGS

FIGS. 1A, 1B, and 1C are example garage door sensor systems.

FIGS. 2A and 2B are schematic diagrams illustrating an example garage door sensor system in the context of an opening garage door.

Like reference symbols in the various drawings indicate like elements.

### DETAILED DESCRIPTION

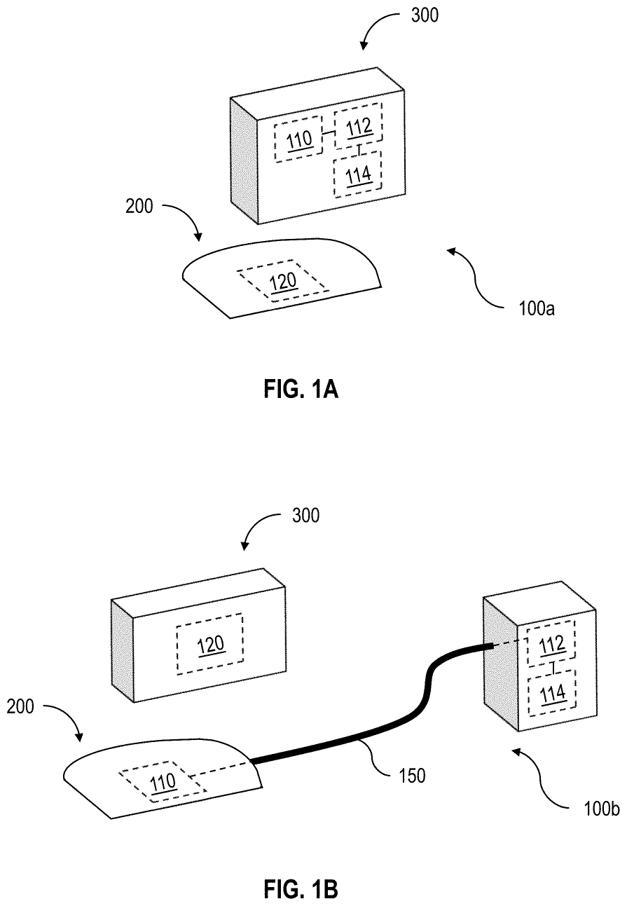

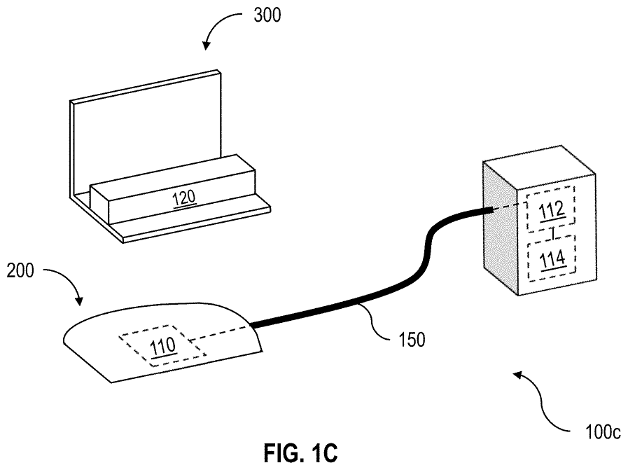

FIG. 1A is a schematic diagram showing an example of a garage door sensor system 100a. The garage door sensor system 100a includes a floor mounting portion 200 and a door mounting portion 300. The garage door sensor system 100a includes a first proximity sensor part 110 connected to a wireless transmitter 112 and a second proximity sensor part 120. The first proximity sensor part 110 is configured to sense when the second proximity sensor part 120 is touching or in close proximity. For convenience of discussion, the first sensor part 110 will be referred to herein as a reed switch and the second sensor part as a magnetic field source 120, but other types of proximity sensors are within the concepts herein. In some implementations (as shown in FIG. 1A), the magnetic field source 120 is housed in the floor mounting portion 200. In some implementations (as shown in FIG. 1B), the magnetic field source 120 housed in the door mounting portion 300. The reed switch 110 is housed in whichever, the floor mounting portion 200 or door mounting portion 300, that does not include the magnetic field source 120, so that when the door is closed the magnetic field source 120 is near the reed switch 110 and when the door is opened, the magnetic field source 120 and reed switch 110 are moved apart.

The floor mounting portion 200 is configured to be mounted on a floor, such as a garage floor, fixed against moving despite being run over by vehicles (car, truck, motorcycle, and/or bicycle), stepped on, and the like. Cars, for example, weigh 2000 pounds or more, so the floor mounting portion 200, in certain instances, is constructed to support one corner (approximately ¼^{th}) of the car plus any impact forces from the vehicle moving over the portion. In some implementations, the floor mounting portion 200 is mounted to the floor by a hammer-set anchor, soft-metal shield, concrete screw, a powder-actuated fastener, and/or another manner of mounting. In some implementations, the floor mounting portion 200 is attached to the floor by an adhesive, for example, an epoxy. In some implementations, the floor mounting portion 200 is fastened to the floor, and an adhesive is also applied to improve the coupling of the floor mounting portion 200 to the floor and/or to improve the hydraulic force between the floor and the fastener. In instances where fasteners are used to mount the floor mounting portion 200, the floor mounting portion 200 may include one or more fastener holes (not shown) each configured to receive the particular fastener used to mount the floor mounting portion 200.

The floor mounting portion 200 is ruggedized and configured to allow a vehicle to repeatedly run over the floor mounting portion 200 and persons to step on the floor mounting portion 200 and remain intact and undamaged (along with any components residing within the floor mounting portion 200). In certain instances, the floor mounting portion 200 is constructed of non-magnetic metal (e.g., aluminum, stainless steel and/or other metal), plastic and/or composite (e.g., resin and fiber composite and/or another composite) that allows efficient communication of magnetic fields therethrough and/or constructed of another material (e.g., steel) with a window or portion of plastic and/or composite positioned to allow efficient communication of magnetic fields. In some implementations, the floor mounting portion 200 includes a rounded portion, beveled portion, or a combination of both to facilitate smooth traversing of a vehicle (or another moving object) over the floor mounting portion 200. For example, rather than being a cubic or rectangular cubic shape, with right corners and its bottom surface abutting the garage floor, the floor mounting portion 200 can have rounded or beveled sidewalls, and in certain instances, is configured as a smooth, continuous shape with no right corners. In some implementations, the floor mounting portion 200 is weatherproofed. For example, the floor mounting portion 200 is waterproof to allow for shallow submersion that might occur from typical rain, and in some instances waterproofed against flooding of a few inches to a few feet of water. The weatherproofing also protects any components residing within the floor mounting portion 200 from the effects of the outer environment, such as excessive heat or cold. In certain instances, the floor mounting portion 200 is weatherproofed by supplying gaskets and/or o-rings between mating parts, constructing the housing in a single piece, and/or potting the interior electronics in a sealant so that water that enters the housing cannot contact the electronics.

The door mounting portion 300 is configured to be mounted on a door, such as a garage door. In some implementations, the door mounting portion 300 is mounted to the door. In some implementations, the door mounting portion 300 is fastened to the door by screws, bolts and/or other fasteners. In some implementations, the door mounting portion 300 is attached to the door by an adhesive. In some implementations, the door mounting portion 300 is mounted to the door with fasteners, and an adhesive is also applied to improve the coupling of the door mounting portion 300 to the door and/or to improve the hydraulic force between the door and the fastener. In some implementations, the door mounting portion 300 is weatherproofed like the floor mounting portion 200. The door mounting portion 300 is constructed of a rugged material, but need not be constructed to withstand a vehicle running over it. Thus, in certain instances, the door mounting portion 300 is constructed of non-magnetic metal, plastic and/or composite that allows efficient communication of magnetic fields therethrough and/or constructed of another material with a window or portion of plastic and/or composite positioned to allow efficient communication of magnetic fields.

The reed switch 110 is an electrical switch operated by an applied magnetic field. The reed switch 110 can be configured to operate normally open or normally closed. In a normally open configuration, the reed switch 110 switches from open to closed in the presence of a nearby magnetic field and back to open when the magnetic field is taken away or turned off. In a normally closed configuration, the reed switch 110 switches from closed to open in the presence of a nearby magnetic field and back to closed when the magnetic field is taken away or turned off. The switching of the reed switch 110 (from open to closed or from closed to open) is a type of signal, and can be used in triggering an event, such as raising an alarm or transmitting data. For example, when the garage door is opened (thereby causing the door mounting portion 300 to move away from the floor mounting portion 200), the reed switch 110 can switch positions and a device monitoring the state of the reed switch 110 can trigger an event.

The wireless transmitter 112, in certain instances, is a radio transmitter or radio transceiver with a circuit and/or controller, an antenna configured for one way and/or two way communications, and a replaceable and/or rechargeable battery. The transmitter 112 communicates pursuant to any one or multiple suitable transmission protocols, including Institute of Electrical and Electronics Engineers (IEEE) 802.11 (e.g., Wi-Fi), IEEE 802.15.4 (e.g., Bluetooth and Zigbee), Z-Wave (an 800-900 MHz protocol promulgated by Silicon Laboratories, Inc.), on frequencies of 319 MHz, 345 MHz, 319 MHz, 900 MHz, cellular (e.g., voice, SMS, and data protocols), and/or in other frequencies and protocols. The circuit or controller of the transmitter 112 is connected to the reed switch 110 to read and communicate the state of the reed switch 110 to another device. In some implementations, the wireless transmitter 112 is with (e.g., embedded in or coupled to) the door mounting portion 300, if the door mounting portion includes the reed switch 110. In certain instances, wireless transmitter 112 can be encased in door mounting portion 300, within an outer housing of the door mounting portion 300 with the outer housing being constructed to allow radio transmissions therethrough. To allow radio transmissions therethrough, the outer housing of the door mounting portion 300, in certain instances, is constructed of plastic and/or composite that allows efficient communication of radio transmissions therethrough and/or constructed of another material with a window or portion of plastic and/or composite positioned in a path of communication of the wireless transmitter 12 (e.g., near the antenna). Otherwise, the wireless transmitter 112 is with (embedded in or coupled to) the floor mounting portion 200 and provided its own housing that is constructed, as discussed above, to allow radio transmissions therethrough. When the wireless transmitter is provided with its own housing, the housing may be weatherproofed like the other components of the system.

When the reed switch 110 switches position (for example, due to the opening of the garage door), the wireless transmitter 112 can wirelessly transmit a signal to another device, for example, a central hub monitoring or controlling security systems at a premises (e.g., house and/or business), an alarm panel, a premises automation system, a computer and/or a mobile device (e.g., a smartphone, tablet, wearable, vehicle and/or another device). In some implementations, the wireless transmitter 112 includes a subscriber identification module (SIM) card to connect to a cellular network. The transmitted signal can trigger another device to perform an operation. For example, the signal can trigger the central hub to raise an alarm or send an alert (for example, in the form of a notification, a text message or an e-mail) to a mobile device. As another example, the signal can be sent to a premises automation system to trigger a surveillance camera to turn on or start recording. Many other examples of uses for the signal exist.

The magnetic field source 120 generates a magnetic field. The magnetic field source 120 can be, for example, a permanent magnet. As mentioned previously, the reed switch 110 interacts with the magnetic field generated by the magnetic field source 120. In some implementations, the magnetic field source 120 is encased in the floor mounting portion 200, within a housing of the floor mounting portion 200.

The garage door system 100a can include additional components 114. In some implementations, the components 114 include one or more sensors, an integrated circuit controller configured to perform specified tasks and/or a processor with separate and/or embedded memory for storing instructions (e.g., software, firmware and/or other instructions) to cause the processor to perform actions. The components 114 can be communicatively coupled to the transmitter 112 and/or reed switch 110. The components 114 can include one or more replaceable and/or rechargeable batteries and/or provided without a battery. The components 114 can be coupled to receive power from the same battery as the wireless transmitter 112. In certain instances, the controller and/or processor within the components 114 supplants the controller in the transmitter 112. In certain instances, the components 114 include a timer that is connected to the reed switch 110 and/or the wireless transmitter 112. The timer can be used, for example, to determine how long the garage door remains open. If the garage door remains open for a predetermined time period (for example, 10 minutes), the wireless transmitter 112 can transmit a signal, for example, an alert to a hub, mobile device and/or another device notifying a user (e.g., the premises owner) that the garage door has remained open for predetermined time period.

FIG. 1B is a schematic diagram showing an example of a garage door sensor system 100b. The garage door sensor system 100b can be substantially similar to (that is, include the same or similar components as) the garage door sensor system 100a shown in FIG. 1A. In some implementations (as shown in FIG. 1B), the magnetic field source 120 is with (embedded in or coupled to) the door mounting portion 300. In some implementations (as shown in FIG. 1B), the reed switch 110 is with (embedded in or coupled to) the floor mounting portion 200. In some implementations, the reed switch 110 is encased in the floor mounting portion 200. In some implementations (as shown in FIG. 1B), the wireless transmitter 112 is connected to the reed switch 110 and the floor mounting portion 200 by a cable 150 (i.e., one or more wires with a sheath). Like the floor mounting portion 200, the cable 150 is configured to allow a vehicle to run over the cable 150 and remain intact. The cable 150 can be made of a sturdy material which can withstand the weight of a vehicle repeatedly running over the cable 150. A non-limiting example of the cable 150 can be a steel or aluminum sheathed cable. In certain instances, the cable 150 is long enough so that when the floor mounting portion 200 is affixed to a garage floor where the door touches the floor, the cable 150 extends beyond the track mechanism supporting the door to allow the wireless transmitter 112 to be positioned out of way of foot and vehicle traffic through the garage door opening.

Using the cable 150 allows for the wireless transmitter 112 to be distanced from the floor mounting portion 200, such that the wireless transmitter 112 can be positioned in a location where a vehicle is not expected to run over. For example, a portion of the cable 150 can run along the floor of the garage, and the wireless transmitter 112 can then be mounted to a nearby wall or a section of the floor that is near a corner of the garage. In some implementations, as an additional layer of protection, the wireless transmitter 112 is encased in a housing that is also configured to allow a vehicle to run over the housing and remain intact (along with any components residing within the housing, such as the wireless transmitter 112). The housing can be made of a sturdy material which can withstand the weight of a vehicle running over the housing. Although not shown, this configuration of connecting the reed switch 110 to the wireless transmitter 112 by a cable (such as cable 150) can also be implemented in the garage door sensor system 100a, in which the cable 150 can connect the wireless transmitter 112 to the door mounting portion 300.

FIG. 1C is a schematic diagram showing an example of a garage door sensor system 100c. The garage door sensor system 100c can be substantially similar to the garage door sensor system 100b shown in FIG. 1B. As shown in FIG. 1C, the door mounting portion 300 can include multiple walls. For example, the door mounting portion 300 includes two walls, one of which is an upstanding wall to facilitate mounting the door mounting portion 300 to the garage door. In FIG. 1C, the two walls of the door mounting portion 300 meet at an angle of 90 degrees, although other angles are contemplated. In some implementations (as shown in FIG. 1C), the magnetic field source 120 is disposed on one of the walls of the door mounting portion 300. The other wall can be used to mount to a garage door. For example, the other wall defines one or more holes through which fastener(s) can pass through and fasten to the garage door. In some implementations, the magnetic field source 120 is fastened to the door mounting portion 300. For example, the magnetic field source 120 can be fastened to the door mounting portion 300 by a soft-metal shield, screw, rivet and/or another type of fastener, or a combination of these. In some implementations, the magnetic field source 120 is attached to the door mounting portion 300 by an adhesive. In some implementations, the magnetic field source 120 is fastened to the door mounting portion 300, and an adhesive is also applied to improve the coupling of the magnetic field source 120 to the door mounting portion 300 and/or to improve the hydraulic force between the door mounting portion 300 and the fastener. In some implementations, the magnetic field source 120 is weatherproofed.

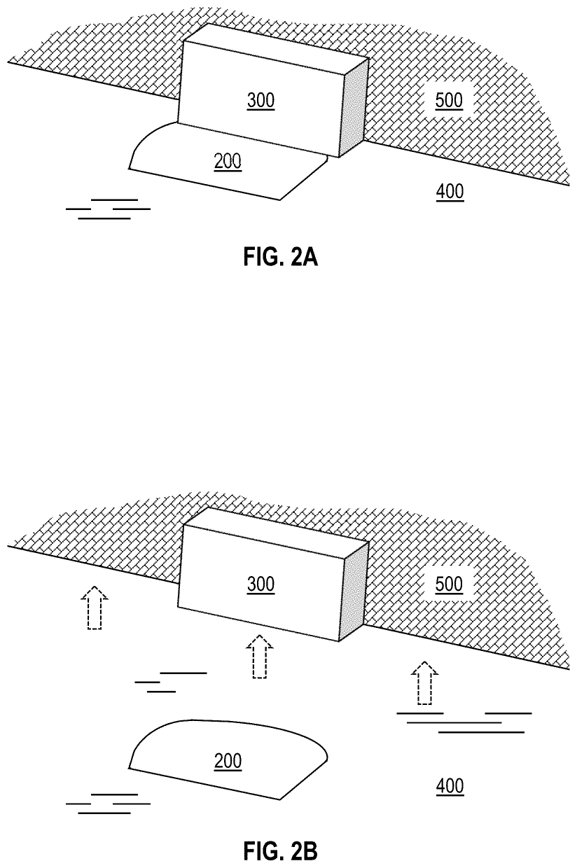

FIGS. 2A and 2B are a schematic showing an example of a garage door sensor system (such as the system 100a or 100b) installed in a garage. The floor mounting portion 200 is installed on a garage floor 400, and the door mounting portion 300 is installed on a garage door 500. In FIG. 2A, the garage door 500 is closed, and the floor mounting portion 200 and door mounting portion 300 are touching or in close proximity to each other (for example, within 0.5 inch away from each other). In FIG. 2B, the garage door 500 is being opened, and the door mounting portion 300 (which is mounted to the garage door 500) moves away from the floor mounting portion 200. In doing so, the reed switch 110 (whether it is coupled to the floor mounting portion 200 or the door mounting portion 300) switches position (from open to closed or from closed to open), which can trigger an event, such as transmittal of a signal by the wireless transmitter 112 to another device (for example, a cell phone). In some cases, another signal can be transmitted when the garage door 500 is closed, and the floor mounting portion 200 and the door mounting portion 300 return to being in close proximity to each other.

In certain instances, the need to make the floor mounting portion 200 rugged and able to withstand being run over by vehicles and stepped on is at odds with including the wireless transmitter 112 with the floor mounting portion 200, because it is difficult to make housing for the floor mounting portion 200 that is both rugged and transmissive to radio frequencies. Such rugged materials and construction are not usually radio transmissive. Providing the wireless transmitter 112 outside of the floor mounting portion 200, for example, in its own housing or in the door mounting portion 300 mitigates that difficulty because the floor mounting portion 200 need not be radio frequency transmissive. Likewise, providing the wireless transmitter 112 with the floor mounting portion 200, but providing a window or portion of radio frequency transmissive material similarly mitigates the difficulty by allowing a major portion of the floor mounting portion 200 to be made of rugged material and construction and a smaller portion be of radio frequency transmissive construction.

Although discussed with respect to a garage door, the concepts can be applied to other types of doors or gates, such as a person door, driveway gate, person gate and/or other door or gate, and especially those that must be rugged.

Particular implementations of the subject matter have been described. Nevertheless, it will be understood that various modifications, substitutions, and alterations may be made without departing from the spirit and scope of this disclosure. Accordingly, the previously described implementations do not define or constrain this disclosure, and other implementations are within the scope of the following claims.

What is claimed is:

1. A garage door sensor system, comprising:
a floor mounting portion configured to withstand a vehicle running over it;
a door mounting portion;
a first proximity sensor part with the floor mounting portion or the door mounting portion;
a second proximity sensor part with the other of the floor mounting portion or the door mounting portion, the first proximity sensor part adapted to change states when the second proximity sensor part is moved between residing apart from the first proximity sensor part and touching or residing in proximity to the first proximity sensor part; and
a wireless transmitter coupled to communicate with the first proximity sensor part and transmit the state of the proximity sensor wirelessly.

2. The garage door sensor system of claim 1, wherein the first proximity sensor part is coupled to the floor mounting portion and the second proximity sensor part is coupled to the door mounting portion.

3. The garage door sensor system of claim 1, wherein the first proximity sensor part is coupled to the door mounting portion and the second proximity sensor part is coupled to the floor mounting portion.

4. The garage door sensor system of claim 3, wherein the wireless transmitter is coupled to the door mounting portion.

5. The garage door sensor system of claim 1, wherein the floor mounting portion comprises a metallic weatherproof housing.

6. The garage door sensor system of claim 5, wherein:
the first proximity sensor part is coupled to the floor mounting portion;
the first proximity sensor part is connected to the wireless transmitter by a cable; and
the wireless transmitter is external to the floor mounting portion enclosed in a radio frequency transmissive, weatherproof housing.

7. The garage door sensor system of claim 1, wherein the floor mounting portion is fastened to a garage floor.

8. The garage door sensor system of claim 7, comprising an adhesive between the floor mounting portion and the garage floor.

9. The garage door sensor system of claim 8, wherein the floor mounting portion is weatherproofed.

10. The garage door sensor system of claim 1, wherein the door mounting portion is fastened to a garage door.

11. The garage door sensor system of claim 10, comprising an adhesive between the door mounting portion and the garage door.

12. The garage door sensor system of claim 11, wherein the door mounting portion is weatherproofed.

13. A method, comprising:
generating a signal by a first proximity sensor part in response to a second proximity sensor part being moved away from the first proximity sensor part;
transmitting, by a wireless transmitter connected to the first proximity sensor part, a first signal in response to the signal of the first proximity sensor part; and
withstanding a vehicle running over the first proximity sensor part.

14. The method of claim 13, wherein:
the second proximity sensor part is coupled to a floor mounting portion coupled to a garage floor;
the first proximity sensor part is coupled to a door mounting portion coupled to a garage door; and
moving the second proximity sensor part away from the first proximity sensor part is a result of opening the garage door, thereby moving the door mounting portion from the floor mounting portion.

15. The method of claim 13, wherein:
the second proximity sensor part is coupled to a door mounting portion coupled to a garage door;
the first proximity sensor part is coupled to a floor mounting portion coupled to a garage floor; and
moving the second proximity sensor part away from the first proximity sensor part is a result of opening the garage door, thereby moving the door mounting portion from the floor mounting portion.

16. The method of claim 15, where the wireless transmitter is external to the floor mounting portion enclosed in a radio frequency transmissive, weatherproof housing.

17. The method of claim 15, comprising:
moving the second proximity sensor part toward from the first proximity sensor part;
switching the first proximity sensor part to a second position in response to moving the second proximity sensor part toward the first proximity sensor part; and
transmitting, by the wireless transmitter, a third signal in response to switching the first proximity sensor part to the second position.

18. A door sensor system, comprising:
a first portion configured to mount to a garage floor and withstand a vehicle repeatedly running over it;
a second portion configured to mount to a garage door;
a sensor adapted to sense proximity of the first and second portions; and
a wireless transmitter coupled to the sensor in a weatherproof housing at least a portion of which is radio transmissive.

19. The door sensor system of claim 18, where the wireless transmitter is in a housing apart from the first portion and coupled to the sensor via a cable configured to withstand a vehicle running over the cable.

20. The door sensor system of claim 18, where the first portion comprises a metallic housing.
